(19) United States
(12) Patent Application Publication
(10) Pub. No.: US 2005/0134036 A1
(43) Pub. Date: Jun. 23, 2005

(54) Method and apparatus for manufacturing a laminated identification card

(76) Inventors: Michael A. Trimble, Mountville, PA (US); J. Michael Zercher, Columbia, PA (US)

Correspondence Address: BAKER & HOSTETLER LLP, Washington Square, Suite 1100, 1050 Connecticut Avenue, N.W., WASHINGTON, DC, 20036, US

(21) Appl. No.: 10/741,450

(22) Filed: Dec. 22, 2003

(51) Int. Cl. G09C 3/00

(52) U.S. Cl. 283/75

(57) ABSTRACT

Methods and apparatus for manufacturing a laminated identification card, which are particularly suited for manufacturing a polyolefinic-based identification card which is printed with a direct to card or thermal print transfer technology.

### FIELD OF THE INVENTION

The present invention relates generally to cards containing information about a user. More particularly, the present invention relates to a method and apparatus for making a laminated identification card which is printed with a direct to card or thermal print transfer technology.

### BACKGROUND OF THE INVENTION

Identification cards are being utilized in greater numbers for access control systems, tracking of personal data, at points of sale, and in many other applications. The identification cards typically contain information about a user or an object to which they are attached. For example, in access control systems an identification card may contain a user's name, employee number, and other employee specific information to allow the employee access to various locations within an employer's facilities. Within hospitals, such identification cards may contain patient specific data such as age, medical condition, allergies to medication, and other data utilized in treating and billing patients. Cards may also be of the form showing credentials and the like. Identification cards may consist of a multi-layer structure having one or more plastic layers surrounding integrated circuits which store the data. Data is transferred to and from the cards either through electrical contacts or radio frequency (RF) transmission. For RF transmission, contactless versions of these identification cards include an antenna for transmitting data to and from the integrated circuits.

One example of such an identification card is disclosed in U.S. Pat. No. 4,855,583. This patent teaches an identification card and method of making a multi-layer structure which has an outer layer of PVC material printed with information and/or a company logo. Another PVC layer having a window sized to receive a proximity electronic data storage device surrounds the storage device which contains an integrated circuit and the antenna. Another PVC layer may be provided with a window for containing a magnetic material which also has user specific data coded thereon. The various PVC layers and outer transparent films are secured to each other by the use of double sided contact adhesive materials dispersed between the layers. The cards may be fabricated in sheets containing a matrix of cards which is then cut into individual cards at the end of the process.

Several problems exist with such arrangements in that PVC is utilized for its rigidity in order to protect the antenna and integrated circuit from breaking upon flexure. Each layer of PVC must be of a prescribed thickness to surround and protect the components. In order to maintain the rigidity required and house the components necessary, these PVC cards tend to be relatively thick as compared to other types of cards such as a credit card. The resulting multi-layer structure is approximately 0.060 inches thick. Additionally, PVC tends to become brittle with age and exposure to ultraviolet rays. This contributes to card failure over time. Additionally, PVC is not an environmentally friendly material.

Another example of a simplified card is shown in U.S. Pat. No. 6,027,027. This patent discloses a luggage tag assembly which is formed by printing an antenna onto a substrate utilizing conductive ink. An integrated circuit chip is then applied to the antenna utilizing a curable epoxy. A top cover having printed information is adhesively applied either at the point of manufacture or at the point of service (POS) such as a luggage check-in counter. Although this design is thinner and more flexible than that of the '583 patent, it is not designed for long life. That is, it is designed to contain information for a luggage itinerary typically completed within one or two days. The assembly is not sealed from moisture or damage due to impact and repeated use. Antennas are typically formed of a thin metallic material which is susceptible to damage if flexed.

What is needed is an improved identification card having storage capability, being thin and flexible, and being constructable by inexpensive printing equipment on-demand.

### SUMMARY OF THE INVENTION

It is therefore a feature and advantage of the present invention to provide a method and apparatus for manufacturing a laminated identification card which allows for die sublimation printing and the like upon a finished product, i.e., direct printing onto the laminated surface itself.

The above and other features and advantages are achieved through the use of a novel identification card lamination process and apparatus as herein disclosed. In accordance with one aspect of the present invention there is provided an identification card, comprising a first outer layer being formed of a substrate having a printable material on an outer surface; a second outer layer being formed of a substrate having a printable material on an outer surface; and an inner layer being formed of a substrate, wherein the inner layer substrate is laminated by and between the first outer layer and the second outer layer.

In accordance with another aspect of the present invention there is provided a method of making an identification card, comprising the steps of supplying an inner substrate to a lamination station; applying a first outer substrate layer to one side of the inner substrate; applying a second outer substrate layer to another side of the inner substrate; and laminating the first outer substrate layer and the second substrate layer to the inner substrate.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 shows a perspective front view of the identification card according to the present invention.

FIG. 2 shows a rear perspective view of the present invention shown in FIG. 1.

FIG. 3 is an exploded perspective view showing the layers of the present invention shown in FIG. 1.

FIG. 4 is a cross-sectional view showing three layers of FIG. 3 in a subassembly of the present invention.

FIG. 5 is a diagrammatic view of the assembly process for the present invention.

FIG. 6 is a flow chart depicting the method of the present invention.

### DESCRIPTION OF THE INVENTION

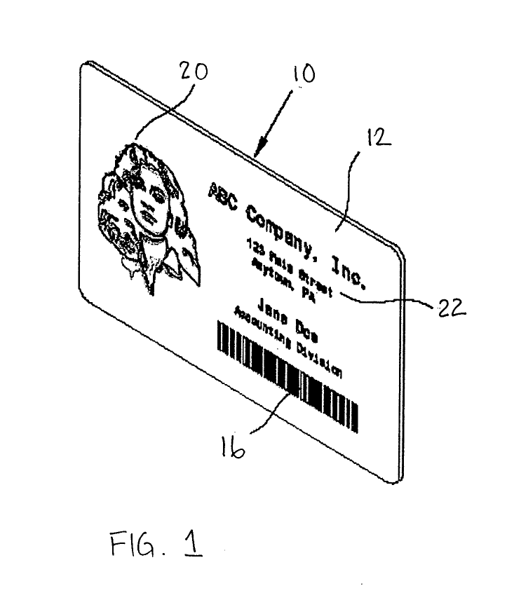

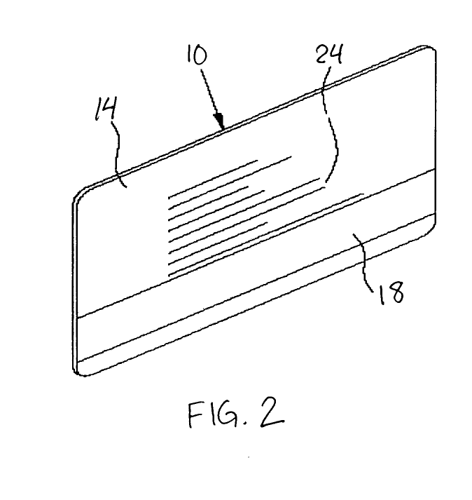

The invention will now be described with reference to the drawing figures, in which like reference numerals refer to like parts throughout. An embodiment in accordance with the present invention provides a method and apparatus for manufacturing a laminated identification card. The invention will first be described generally with reference to FIGS. 1 and 2. The identification card 10 is a thin card having a front side 12 and a back side 14. The front side 12 may have printed information 22 along with diagrammatic or photographic information 20 which can be printed on-demand by a user. An offset printing method may be used. A bar code 16 may also be provided on the front side 12. Similarly, the back side 14 contains printed information 24 and a magnetic strip 18. It should be understood that while the bar code 16, graphic information 20 and printed information 22 are shown on the front side 12, this information may be placed on the back side 14. Similarly, the elements of the back side 14 may be placed on the front side 12. Inside the identification card 10 are a plurality of layers which may contain an integrated circuit for storing additional user specific information, an antenna for transmitting data between the integrated circuit and another device, or contacts for transmitting data between the identification card 10 and another device (not shown).

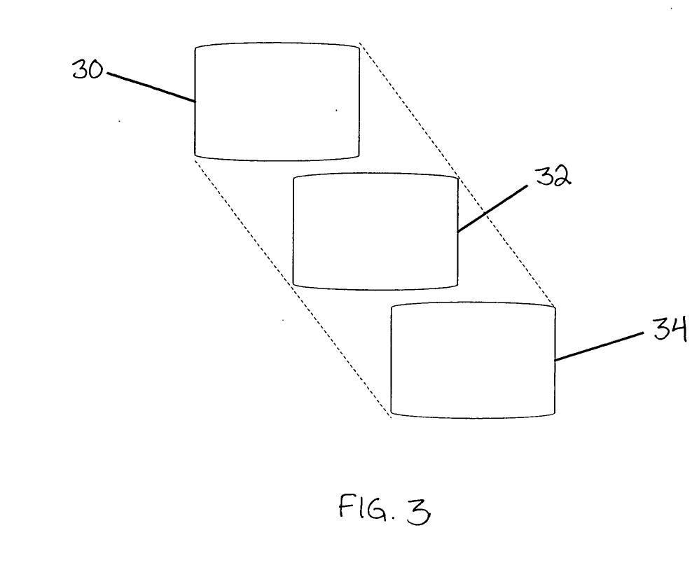

Each of the major components of the identification card 10 will now be described in greater detail with reference to FIGS. 3 & 4. The identification card 10 is constructed from a plurality of layers 30, 32, 34. A first outer layer 30 is a substrate formed of a clear plastic material preferably DITX laminate, which is manufactured by Transilwrap of Franklin Park, Ill. It should be understood, however, that other suitable materials which are capable of receiving printed material may be utilized. The outer surface of the first outer layer 30 has printed information 22 along with diagrammatic or photographic information 20 and an optional bar code 16. These are applied utilizing a standard PVC printer or other suitable printer. An inner layer 32 serves as a substrate with optional printing on its surface as desired and is preferably made of a polyolefinic-based material such as TESLIN which is manufactured by PPG Industries of Pittsburgh, Pa.

The second outer layer 34 is formed preferably of a printable substrate material. Once again, it should be understood that any suitable thin material capable of being PVC printable or a standard laminate such as DITX laminating film may be utilized for the substrate. Printed on an inner surface of the second outer layer 34 may be printed information 24 and/or a magnetic strip 18. An antenna and/or integrated circuit (not shown) may be fixed to the inner surface of layer 34 utilizing a curable epoxy as is well known in Flip Chip technology.

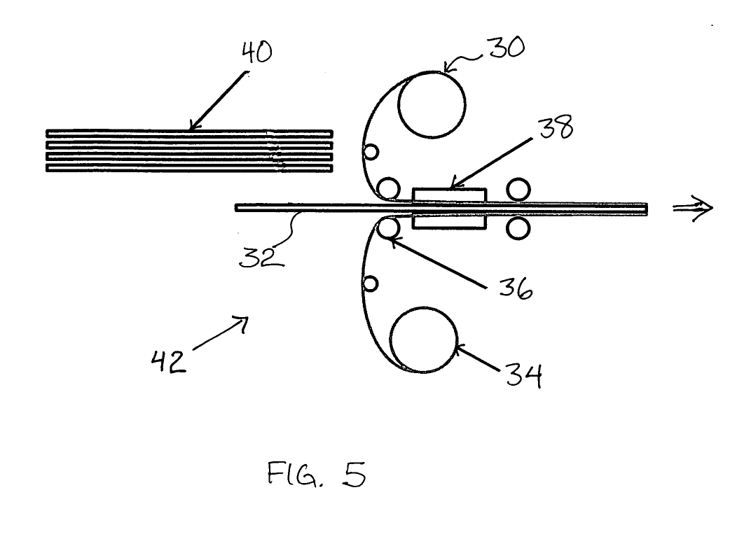

Referring to FIGS. 5 & 6, in the process, a substrate 32 is supplied in sheets 40 which are fed first through pinch rollers 36 of a laminating station 42 where the first outer layer 30 and the second outer layer 34 are applied. The first outer layer 30 and the second outer layer 34 are then cured to the substrate 32 through a heating source 38 for lamination purposes. Next, the combined/laminated substrate passes a trim station wherein the cards are cut into variously sized identification products as desired. For example, a user may define a string of identification cards to match a desired size of a company logo or that of a standard sized credit card.

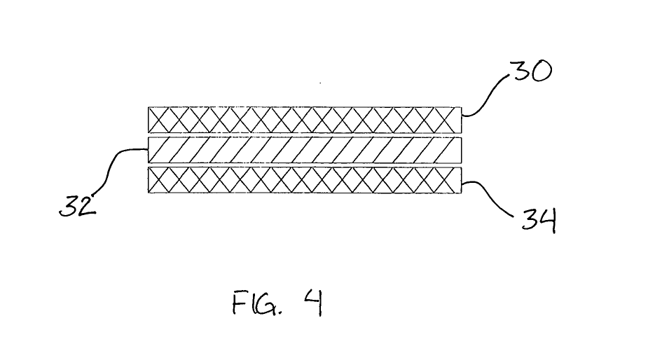

Next, each individual card at this stage contains a first outer layer 30, a second outer layer 34 and an inner layer 32 as shown in FIG. 4.

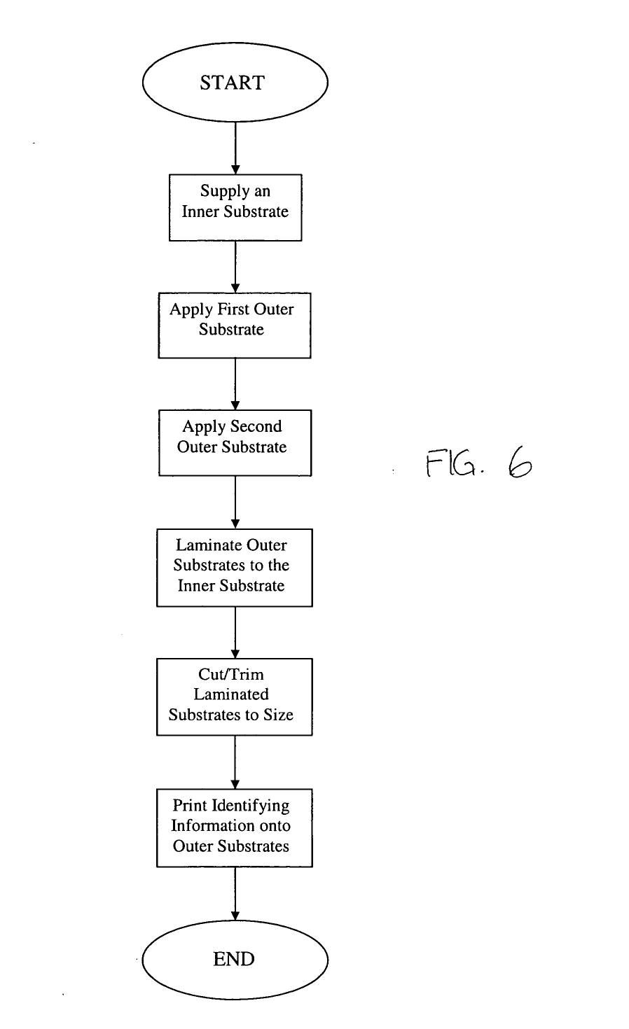

It should be understood by those reasonably skilled in the art that the entire process of FIG. 6 can be completed at a card manufacturer's location based on customer specifications, thereby eliminating the need for a point of service or a customer location assembly or finishing process where identification cards are to be used. Thus, streamlining the manufacturing process and saving the customer or user time and costs associated with printing equipment and the like. Additionally, no specialized equipment is required to conduct the printing and trimming operations thereby reducing expenses.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

1. An identification card, comprising:
a first outer layer being formed of a substrate having printable material on an outer surface; and
a second outer layer being formed of a substrate having printable material on an outer surface.

2. The identification card of claim 1, further comprising an inner layer being formed of a substrate.

3. The identification card of claim 2, wherein said inner layer substrate is laminated by and between said first outer layer and said second outer layer.

4. The identification card of claim 3, wherein said inner layer substrate is formed from a printable plastic material.

5. The identification card of claim 1, wherein the first outer layer substrate is formed from clear laminate having a substrate receptive to PVC printing.

6. The identification card of claim 1, wherein the second outer layer substrate is formed from clear laminate having a substrate receptive to PVC printing.

7. An identification card, comprising:
a first outer layer; and
a second outer layer, wherein said first outer layer and said second outer layer are laminated about an inner substrate layer formed from a printable plastic material.

8. The identification card of claim 7, wherein said first outer layer has printed material on an outer surface.

9. The identification card of claim 8, wherein said second outer layer has printed material on an outer surface.

10. The identification card of claim 7, wherein said first outer layer and said second outer layer are formed of a printable material.

11. A method of making an identification card, comprising the steps of:
supplying an inner substrate to a lamination station;
applying a first outer substrate layer to one side of said inner substrate;
applying a second outer substrate layer to another side of said inner substrate.

12. The method of claim 11, further comprising the step of laminating said first outer substrate layer and said second outer substrate layer to said inner substrate.

13. The method of claim 12, further comprising the step of trimming the laminated substrate to size.

14. The method of claim 12, wherein said first outer substrate layer is formed from a clear laminate having a substrate receptive to PVC printing.

15. The method of claim 14, wherein said second outer substrate layer is formed from a clear laminate having a substrate receptive to PVC printing.

16. The method of claim 12, wherein said inner layer substrate is formed from a printable plastic material.

17. The method of claim 13, further comprising the step of printing information on an outer surface of said first outer substrate layer.

18. The method of claim 17 further comprising the step of printing information on an outer surface of said second outer substrate layer.

19. An identification card, comprising:
means for supplying an inner substrate to a lamination station;
means for applying a first outer substrate layer to one side of said inner substrate;
means for applying a second outer substrate layer to another side of said inner substrate.

20. The identification card of claim 19, further comprising means for laminating said first outer substrate layer and said second substrate layer to said inner substrate.

21. The identification card of claim 20, further comprising means for trimming the laminated substrate to size.

22. The identification card of claim 20, wherein said first outer substrate layer is formed from clear laminate having a substrate receptive to PVC printing.

23. The identification card of claim 22, wherein said second outer substrate layer is formed from clear laminate having a substrate receptive to PVC printing.

24. The identification card of claim 20, wherein said inner layer substrate is formed from TESLIN.

25. The identification card of claim 21, further comprising a means for printing information on an outer surface of said first outer substrate layer.

26. The identification card of claim 25, further comprising a means for printing information on an outer surface of said second outer substrate layer.
